(19) United States
(12) Patent Application Publication
(10) Pub. No.: US 2026/0058427 A1
(43) Pub. Date: Feb. 26, 2026

(54) TERMINAL INSERTION UNIT AND TERMINAL INSERTION METHOD

(71) Applicant: Yazaki Corporation, Tokyo (JP)

(72) Inventors: Shingo NAKAJIMA, Makinohara-shi (JP); Yukitaka Sonohara, Makinohara-shi (JP)

(73) Assignee: Yazaki Corporation, Tokyo (JP)

(21) Appl. No.: 19/377,447

(22) Filed: Nov. 3, 2025

Related U.S. Application Data
(63) Continuation of application No. PCT/JP2024/015857, filed on Apr. 23, 2024.

(30) Foreign Application Priority Data
May 24, 2023 (JP) 2023-085336

(51) Int. Cl. H01R 43/20

(52) U.S. Cl. CPC H01R 43/20

(57) ABSTRACT

It is provided to efficiently repeatedly perform a terminal insertion with respect to a connector housing. A terminal insertion unit includes a housing pallet, a pallet holding frame configured to hold two and more housing pallets in a state of being able to move along a circulation route from a housing supply position, a standby position, a terminal insertion position, and a housing removal position in this sequence, and to return to the housing supply position after housing removal, a terminal insertion portion, and a pallet driving portion configured to make housing pallets to move along the circulation route so as to make, during a period from one of the housing pallet receives the housing supply until the terminal insertion at the terminal insertion position is finished, other housing pallets to standby at the standby position.

### TECHNICAL FIELD

The present disclosure relates to a terminal insertion unit and a terminal insertion method for inserting an end portion terminal of an electric wire with terminal into a cavity of a connector housing.

The present application is a continuation application of International Application No. PCT/JP2024/015857, filed April 23, 2024, whose priority is claimed on Japanese Patent Application No. 2023-085336, filed May 24, 2023. The contents of both the International Application and the Japanese Patent Application are incorporated herein with reference.

### BACKGROUND ART

Conventionally, when producing a wire harness where a connector is provided in an end portion thereof, a terminal insertion unit for inserting an end portion terminal of an electric wire with terminal into a cavity of a connector housing is utilized (for example, see Patent Document 1). The terminal insertion unit recited in this Patent Document 1 is configured as an apparatus in which when a connector housing as a target of the terminal insertion is attached, the terminal of the end portion of the electric wire with the terminal is automatically inserted into the cavity. When the insertion has finished, the connector housing is removed to be temporarily stored by a predetermined storage tool.

### [CITATION LIST]

### [Patent Documents]

[Patent Document 1] JP 2009-64722A

### SUMMARY OF THE INVENTION

### [TECHNICAL PROBLEM]

Here, regarding the above-described terminal insertion unit, in a case in which the terminal insertion with respect to the connector housing is repeatedly performed, it is impossible to, until the terminal insertion with respect to one connector housing has finished and the connector housing is removed, attach the next connector housing thereto, thus there is a room for the improvement in terms of work efficiency.

Therefore, the present invention is made in consideration of the above-mentioned circumstances, and a purpose of the present invention is to provide a terminal insertion unit and a terminal insertion method capable of efficiently performing the terminal insertion with respect to the connector housing.

### [Solution to Problem]

In order to solve the above-described problem, a terminal insertion unit is characterized by including two and more housing pallets to which one and more housing holders are attached, the housing holder being able to hold a connector housing in which multiple cavities into which end portion terminals of electric wires with terminal are insertable respectively; a pallet holding frame configured to hold two and more housing pallets in a state of being able to move along a circulation route from a housing supply position where the connector housing is supplied to be held by the housing holder, a standby position where the housing pallets temporarily standby after housing holding, a terminal insertion position where the end portion terminals of the electric wires with terminal are inserted into the cavities of the connector housings, and a housing removal position where the connector housings after terminal insertion are removed from the housing holders in this sequence, and to return to the housing supply position after housing removal; a terminal insertion portion configured to insert the end portion terminals into the cavities of the connector housings in the housing pallets positioned at the terminal insertion position; and a pallet driving portion configured to make two and more housing pallets to move along the circulation route so as to make, during a period from one of the housing pallet receives the housing supply at the housing supply position until the terminal insertion at the terminal insertion position is finished, other housing pallets to standby at the standby position after the housing supply.

In order to solve the above-described problem, a terminal insertion method is characterized by including a housing supply step of positioning, among two and more housing pallets to which one and more housing holders are attached, the housing holder being able to hold a connector housing in which multiple cavities into which end portion terminals of electric wires with terminal are insertable respectively, one of the housing pallet, in a circulation route of moving from a housing supply position, to a standby position, to a terminal insertion position, to a housing removal position in this sequence and then return to the housing supply position, at the housing supply position, and supplying the connector housing so as to be held by the housing holder; a standby step of making one of the housing pallet to be positioned at the standby position so as to standby until the terminal insertion position becomes vacant in a case where other housing pallet is positioned at the terminal insertion position in prior to one of the housing pallet after housing holding, and positioning the one housing pallet at the terminal insertion position after standby; a terminal insertion step of inserting the end portion terminal of the electric wire with terminal into the cavity of the housing pallet positioned at the terminal insertion position; and a housing removal step of positioning the housing pallet after terminal insertion at the housing removal position to remove the connector housing from the housing holder.

### [Effect of the Invention]

According to the above-described terminal insertion unit and the terminal insertion method, it is possible to efficiently perform the terminal insertion with respect to the connector housing.

### BRIEF DESCRIPTION OF THE DRAWINGS

FIG. 1 is a perspective view showing a terminal insertion unit according to an embodiment.

FIG. 2 is a schematic block diagram showing a terminal insertion unit shown in FIG. 1.

FIG. 3 is a view showing a housing pallet, a pallet holding frame, and a pallet driving portion shown in FIG. 1 and FIG. 2 in a state of removing other elements from the perspective view shown in FIG. 1.

FIG. 4 is an enlarged perspective view showing one among the three housing pallets shown in FIG. 3 in an enlarged scale.

FIG. 5 is a view showing a first transporting portion shown in FIG. 1 and FIG. 2 together with an electric wire with terminal that is held by an electric-wire holding tool.

FIG. 6 is a view showing the first transporting portion shown in FIG. 5 together with a tilt correction portion as a transport destination of the electric wire with terminal.

FIG. 7 is a view showing the tilt correction portion shown in FIG. 1 and FIG. 2 together with the electric wire with terminal as a correction target.

FIG. 8 is a schematic side-view block diagram showing the tilt correction portion shown in FIG. 7.

FIG. 9 is a descriptive view for describing a tilt correction performed at the tilt correction portion shown in FIG. 7 and FIG. 8.

FIG. 10 is a view showing a second transporting portion shown in FIG. 2 together with the tilt correction portion as a transport source.

FIG. 11 is a view showing the second transporting portion shown in FIG. 10 together with part of the terminal insertion portion as the transport destination of the electric wire with terminal.

FIG. 12 is a view showing the terminal insertion portion shown in FIG. 1 and FIG. 2 while focusing on a detection function of a front-end position of an end portion terminal.

FIG. 13 is a view showing the terminal insertion portion shown in FIG. 12 while focusing on a detection function of a position of the cavity as the insertion target.

FIG. 14 is a schematic side-view block diagram showing the terminal insertion portion shown in FIG. 12 and FIG. 13.

FIG. 15 is a schematic view showing a terminal-side positional deviation detected for the end portion terminal at an insertion control portion of the terminal insertion portion shown in FIG. 12 to FIG. 14.

FIG. 16 is a schematic view showing a cavity-side positional deviation detected for the cavity as the insertion target at the insertion control portion of the terminal insertion portion shown in FIG. 12 to FIG. 14.

FIG. 17 is a schematic view showing procedures of inserting the end portion terminal after the positional deviation correction into the cavity as the insertion target in the terminal insertion portion shown in FIG. 12 to FIG. 14.

FIG. 18 is a flowchart schematically showing a flow of processing of a terminal insertion method executed in the terminal insertion unit 1 shown in FIG. 1 to FIG. 17.

### DESCRIPTION OF EMBODIMENTS

Hereinafter, an embodiment of a terminal insertion unit and a terminal insertion method will be described.

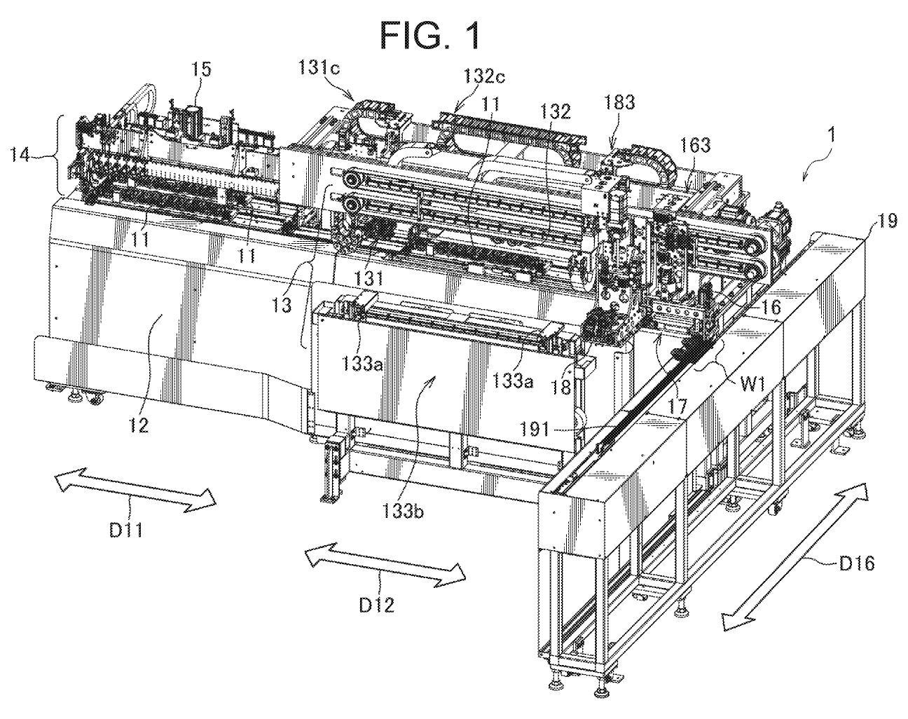

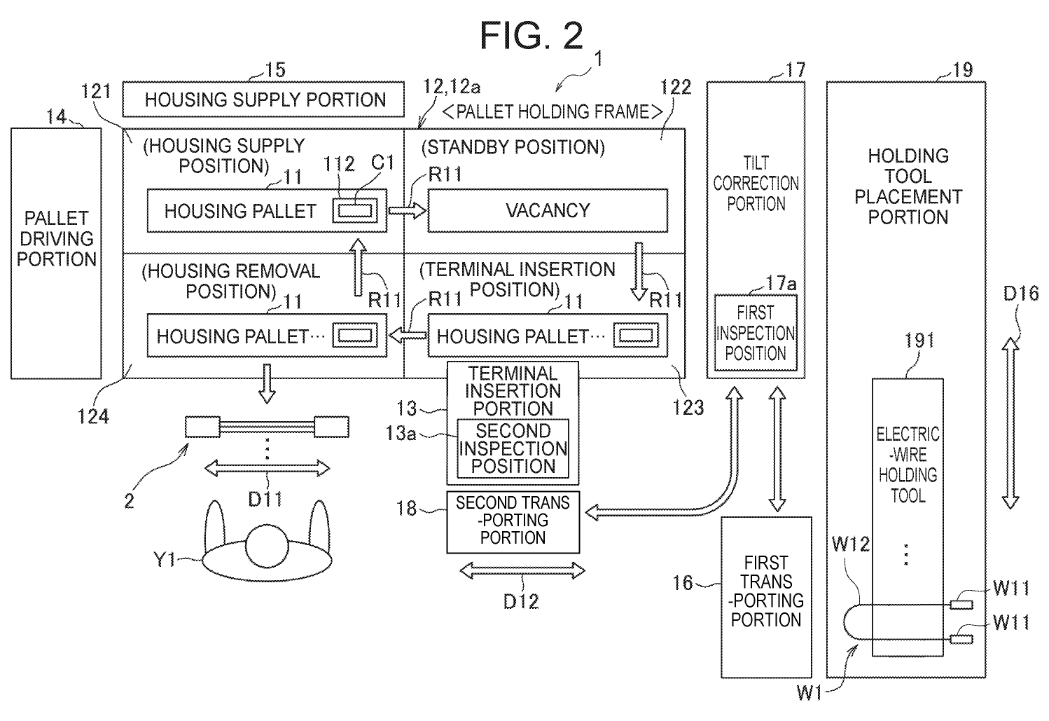

FIG. 1 is a perspective view showing a terminal insertion unit according to an embodiment, and FIG. 2 is a schematic block diagram showing the terminal insertion unit shown in FIG. 1.

A terminal insertion unit 1 according to the present embodiment, as an example, is a working unit for manufacturing a connector-attached electric-wire bundle 2 that constitutes at least a part of a wire harness that is mounted and routed in a vehicle or the like. According to this terminal insertion unit 1, an end portion terminal W11 of an electric wire with terminal W1 supplied via an electric-wire holding tool 191 is inserted into a connector housing C1 that is held by a housing pallet 11. The electric wires with terminal W1 according to the present embodiment are held by the electric-wire holding tool 191 in a necessary number for manufacturing one connector-attached electric-wire bundle 2. Each electric wire with terminal W1 is a configuration in which the end portion terminals W11 are connected to both ends of an electric wire portion W12 such that as shown in FIG. 2, it is held by the electric-wire holding tool 191 at the two end portions in a state of being bent in a U shape. The plurality of electric wires with terminal W1 are picked up one by one, and the end portion terminal W11 at each of the two ends thereof is inserted into the corresponding connector housing C1. The terminal insertion unit 1 is configured to repeatedly perform such terminal insertion to manufacture the connector-attached electric-wire bundle 2, and the manufactured connector-attached electric-wire bundle 2 is taken out from the terminal insertion unit 1 by an operator Y1.

This terminal insertion unit 1 includes a housing pallet 11, a pallet holding frame 12, a terminal insertion portion 13, a pallet driving portion 14, a housing supply portion 15, a first transporting portion 16, a tilt correction portion 17, a second transporting portion 18, and a holding tool placement portion 19. Hereinafter, each portion will be described with reference to other drawings.

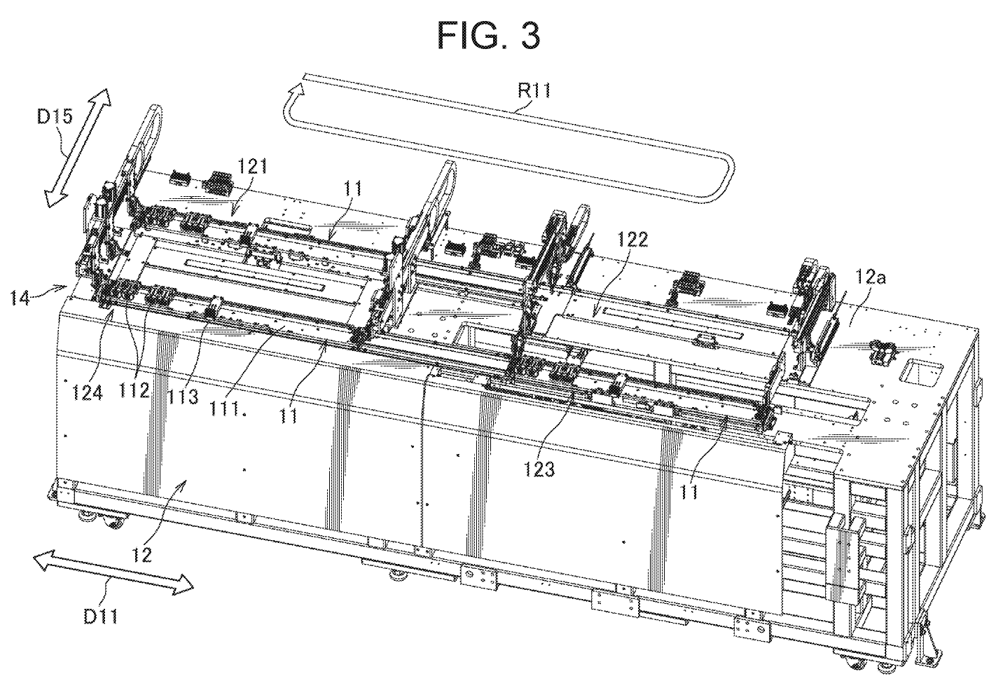

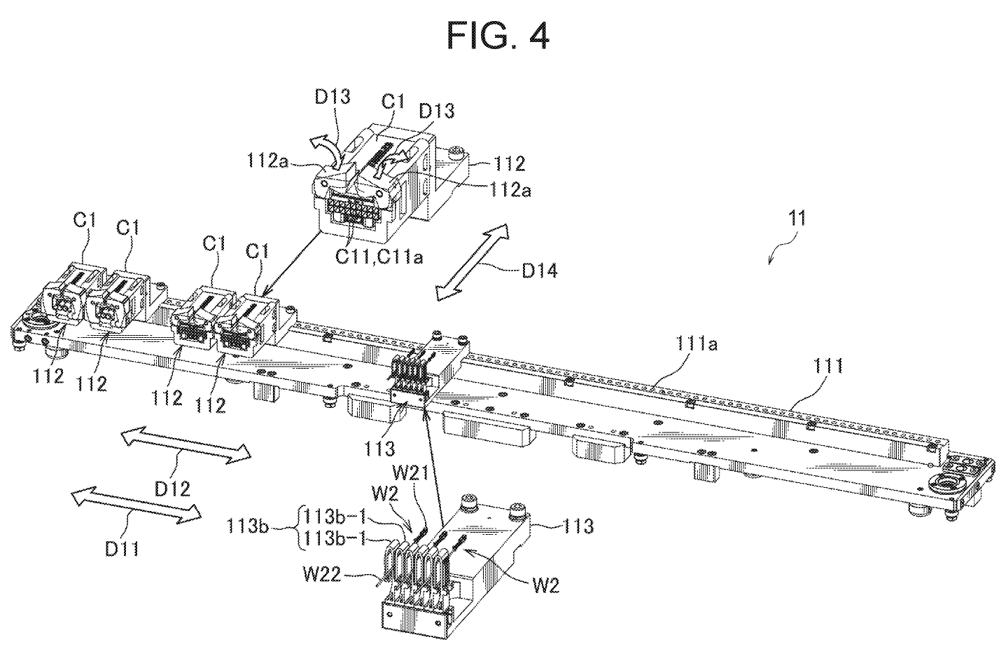

FIG. 3 is a view showing the housing pallet, the pallet holding frame, and the pallet driving portion shown in FIG. 1 and FIG. 2 in a state of removing other elements from the perspective view shown in FIG. 1. FIG. 4 is an enlarged perspective view showing one among the three housing pallets shown in FIG. 3 in an enlarged scale.

The housing pallet 11 is a member detachably holding a plurality of connector housings C1, and includes a pallet main body 111, a plurality of housing holders 112, and a single electric-wire temporary holder 113. The connector housing C1 as a target to be held is a resin housing with a rectangular block shape appearance while being provided with multiple cavities C11 into which the end portion terminal W11 of the electric wire with terminal W1 is insertable.

The pallet main body 111 is a strip rod-shaped member and the pallet main body 111 is positioned on the pallet holding frame 12 at a housing removal position 124 described below such that a longitudinal direction D12 thereof extends along a left-right direction D11 as viewed from the operator Y1.

The housing holder 112 is a member being able to hold the connector housing C1. This housing holder 112 holds the connector housing C1 by a pair of arms 112a being able to open and close in an open-close direction D13 to hold the connector housing C1. A plurality of the housing holders 112 are attached thereto in a state of being arranged in a line in the longitudinal direction D12 of the pallet main body 111. Also, each housing holder 112 is attached to the pallet main body 111 so as to make a terminal insertion port C11a in the cavity C11 to be exposed and hold the connector housing C1 while making the terminal insertion direction D14 to intersect the pallet main body 111.

Then, according to the present embodiment, various types of housing holders 112 corresponding to different sizes are attached to the pallet main body 111 so as to be able to hold various types of connector housings C1 having different sizes with each other. In the example shown in FIG. 4, in order to make it possible to hold two types of connector housings C1, two types of housing holders 112 with different arm shapes are shown, and two of each type of housing holders 112 are attached to the pallet main body 111, respectively. Also, the housing holder 112 is attached to the pallet main body 111 with the attachment position to be changeable in the longitudinal direction D12. The attachment of the housing holder 112 is performed by the screw fastening, and a plurality of screw holes 111a are formed in the pallet main body 111 to be aligned in a line in the longitudinal direction D12 such that it is possible to change the attachment positions. The plurality of housing holders 112 are arranged in predetermined intervals and sequence based on the connector arrangement of the finished connector-attached electric-wire bundle 2 and attached to the pallet main body 111.

The electric-wire temporary holder 113 is a member for temporarily holding one or more non-inserted electric wires W2 having non-inserted terminals W21 that are not inserted into the cavity C11 of the connector housing C1, and it is attached in the pallet main body 111 to be adjacent to the housing holder 112. The attachment of the electric-wire temporary holder 113, similar to that of the housing holder 112, is performed by the screw fastening such that the attachment position is suitably changeable. In this electric-wire temporary holder 113, one or more electric wire clamping portions 113b are provided for clamping an electric wire portion W22 of an uninserted electric wire with terminal W2 by a pair of U-shaped leaf spring members 113b-1 arranged adjacent to each other. The uninserted electric wire with terminal W2 is inserted and clamped between the U-shaped leaf spring members 113b-1 in each electric wire clamping portion 113b.

According to the present embodiment, three housing pallets 11 having the configuration described above, as shown in FIG. 1 and FIG. 3, are held by the pallet holding frame 12. The pallet holding frame 12 is a frame member having an appearance of a rectangular block shape that is placed on a specified installation surface with the ground at the lower side and holds three housing pallets 11 on a plane of an upper surface of a top plate portion 12a having the rectangular plate shape that conforms to the installation surface. The upper surface of the top plate portion 12a is divided into four 2 x 2 areas, and the three housing pallets 11 are movably held in the pallet holding frame 12 so that the three housing pallets 11 move cyclically through these four areas.

The above-described four areas on the top plate portion 12a of the pallet holding frame 12 are referred to a housing supply position 121, a standby position 122, a terminal insertion position 123, and a housing removal position 124. The housing pallet 11 is held by the pallet holding frame 12 in a state in which it can move along a circulation route R11 that connects these four areas. The circulation route R11 is a route that moves in an order of the housing supply position 121, the standby position 122, the terminal insertion position 123, and the housing removal position 124, and then returns to the housing supply position 121 again.

The housing supply position 121 is an area where the connector housing C1 is supplied and held by the housing holder 112 of the housing pallet 11. The standby position 122 is an area where the housing pallet 11 temporarily standbys after holding the housing. The terminal insertion position 123 is an area where the end portion terminal W11 of the electric wire with terminal W1 is inserted into the cavity C11 of the connector housing C1. Then, the housing removal position 124 is an area where the connector housing C1 is removed from the housing holder 112 after the terminal is inserted therein. When the terminal insertion into all the connector housings C1 supplied at the housing supply position 121 for one housing pallet 11 is completed and it moves to the housing removal position 124, the removal of all of the connector housings C1 is performed. Due to the removal here, the connector-attached electric wire bundle 2 is taken out as an output from the terminal insertion unit 1. According to the present embodiment, the removal of the connector housings C1 at the housing removal position 124 is performed manually by the operator Y1.

Taking the manual operations at the housing removal position 124 into consideration, the circulation route R11 connecting the four areas is the following circular route on the plane of the top plate portion 12a of the pallet holding frame 12. At first, the housing removal position 124 is an area on the front side of the unit facing the operator Y1. To facilitate the removal described here, the connector housing C1 is held in the housing holder 112 as follows. That is, the connector housing C1 is held in the housing holder 112 such that the rear side, into which the end terminal W11 is inserted and from which the terminal-attached electric wire W1 extends, faces the side of the operator Y1 at the housing removal position 124.

A terminal insertion position 123, which is a passing area immediately preceding the housing removal position 124, is an area adjacent to the housing removal position 124 in the left-right direction D11 as seen by the operator Y1 on the front side of the unit. The housing supply position 121 to which the empty housing pallet 11 is moved from the housing removal position 124 after the removal of the housing is an area at the deep side of the unit separated toward the deep side from the housing removal position 124 as viewed in a depth direction D15 by the operator Y11. Then, the standby position 122 where the housing pallet 11 standbys before the terminal insertion is adjacent to the housing supply position 121 in the left-right direction D11 at the deep side of the unit, and is an area separated from the terminal insertion position 123 toward the deep side in the depth direction D15.

The terminal insertion portion 13 shown in FIG. 1 and FIG. 2 is a mechanical portion for inserting the end portion terminal W11 into the cavity C11 of the connector housing C1 in the housing pallet 11 positioned at the terminal insertion position 123 in the circulation route R11. The terminal insertion portion 13 will be described in detail later together with other portions.

The terminal insertion unit 1 is provided with a pallet driving portion 14 for moving the housing pallet 11 along this circulation route R11 while the terminal insertion by the terminal insertion portion 13 is performed during the procedure. According to the present embodiment, three housing pallets 11 are provided to move along the circulation route R11, leaving one of the housing supply position 121, the standby position 122, the terminal insertion position 123, and the housing removal position 124 to be open. The pallet driving portion 14 makes these three housing pallets 11 to move. At this time, the pallet driving portion 14, during a period between the time when one of the three housing pallets 11 receives the housing supply at the housing supply position 121 until the time when the terminal insertion has been completed at the terminal insertion position 123, moves another one housing pallet 11 to move as follows. That is, during the above-mentioned period, this housing pallet 11 receives the housing supply at the housing supply position 121 and then standbys at the standby position 122. In most cases, since it takes more time for the terminal insertion than the housing supply, during the period while one housing pallet 11 is receiving the terminal insertion, another housing pallet 11 to which the housing supply has been performed standbys at the standby position 122. Also, at this time, regarding the remaining housing pallets 11, if the terminal insertion has already been performed, the removal of the connector housing C1 will be performed at the housing removal position 124. Furthermore, if the terminal insertion is scheduled for this housing pallet 11, it is transported to the housing supply position 121 to receive the housing supply. Then, this housing pallet 11 remains at the housing supply position 121 until the standby position 122 becomes available.

Also, in the vicinity of the housing supply position 121, as shown in FIG. 1 and FIG. 2, the housing supply portion 15 is provided. The housing supply portion 15 stocks the connector housings C1, and automatically supplies the connector housings C1 to the housing pallet 11 positioned at the housing supply position 121 to make them to be held by the housing holders 112. The housing pallet 11 receiving the housing supply from the housing supply portion 15 is sent to the terminal insertion position 123 via the standby position 122 to receive the terminal insertion by the terminal insertion portion 13.

In this terminal insertion portion 13, the electric wire with terminal W1 is transported by the first transporting portion 16 and the second transporting portion 18 from the electric-wire holding tool 191 in the holding tool placement portion 19 while receiving the tilt correction described below by the tilt correction portion 17 during the procedure.

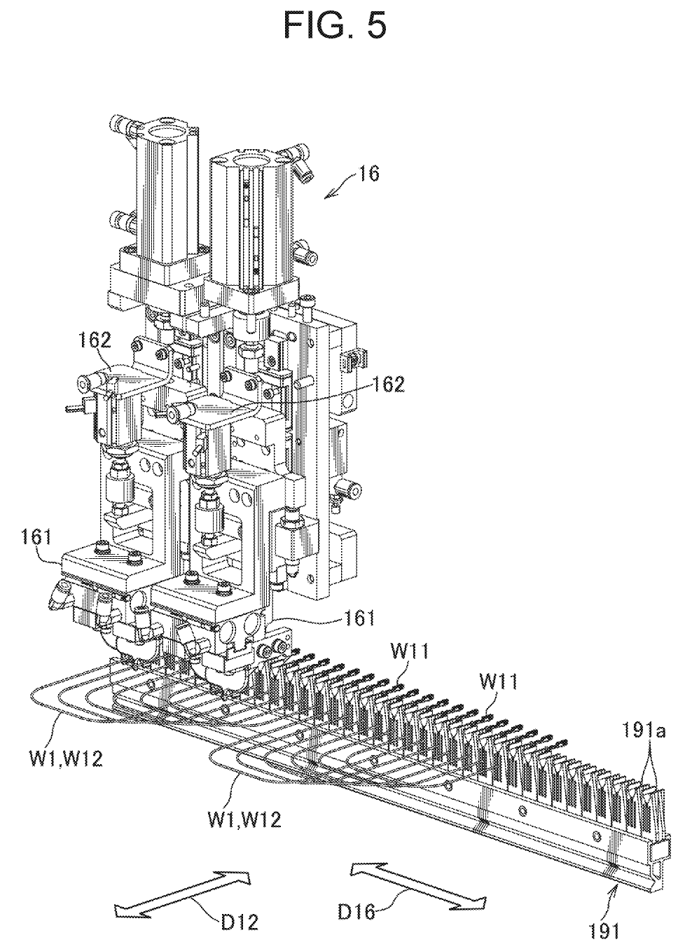

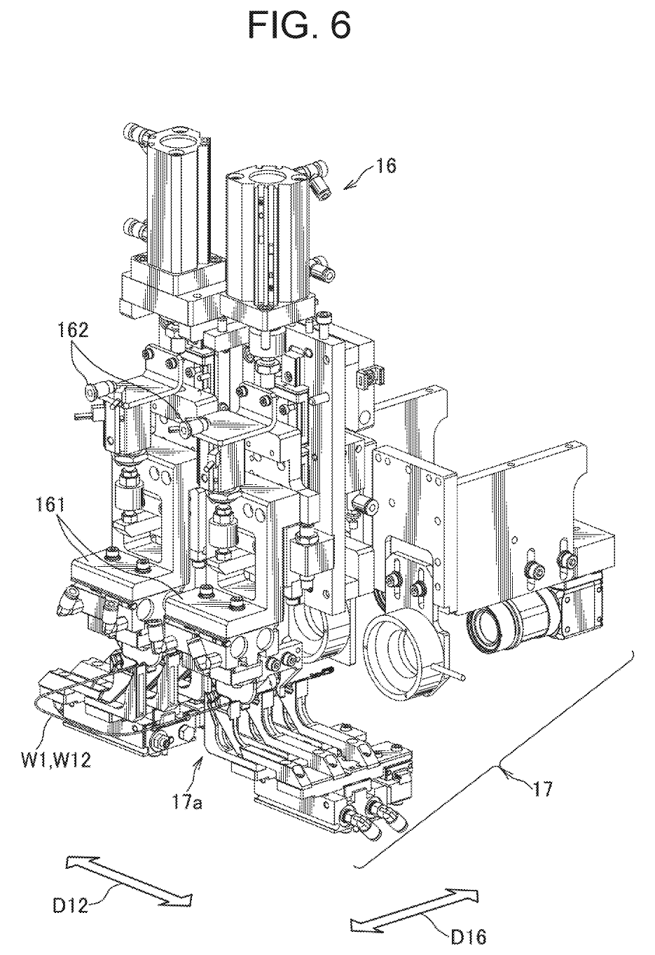

FIG. 5 is a view showing the first transporting portion shown in FIG. 1 and FIG. 2 together with an electric wire with terminal that is held by the electric-wire holding tool, and FIG. 6 is a view showing the first transporting portion shown in FIG. 5 together with the tilt correction portion as the transport destination of the electric wire with terminal.

The first transporting portion 16 grips the electric wire with terminal W1 held by the electric-wire holding tool 191 and transports it to the first inspection position 17a in the tilt correction portion 17. The electric-wire holding tool 191 is a rod-shaped member that holds the electric wire portion W12 near the end portion terminal W11 at both ends of the electric wire with terminal W1. In the electric-wire holding tool 191, holding slits 191a, into which the electric wire portion W12 is inserted, are formed to be arranged in a line in a rod length direction D16. Each electric wire with terminal W1 is held by the electric-wire holding tool 191 at two end portions thereof in a state of being bent in a U shape as described above. The first transporting portion 16 picks up the electric wire with terminal W1 one by one from the electric-wire holding tool 191 by gripping both end portions of the electric wire with terminal W1 in the state of being bent in the U shape. The first transporting portion 16 includes a pair of gripping mechanisms 161 that grip both end portions of the electric wire with terminal W1, a gripping driving mechanism 162 that drives each gripping mechanism 161, and a moving mechanism 163 (see FIG. 1) that moves the pair of gripping mechanisms 161 to the first inspection position 17a.

In the holding tool placement portion 19, the electric-wire holding tool 191 is arranged in a posture to be substantial orthogonal to the longitudinal direction D12 and the rod length direction D16 of the housing pallet 11 at the terminal insertion position 123. The electric-wire holding tool 191, wherein the plurality of electric wires with terminal W1 are set therein during the prior step, is transported to the holding tool placement portion 19 by the operator Y1 and placed in the above-described orthogonal posture. Regarding the first transporting portion 16, after the pair of gripping mechanisms 161, in a pick-up posture arranged in the rod length direction D16, grip both end portions of one electric wire with terminal W1 from the electric-wire holding tool 191, the gripping mechanism 161 is turned 90 degrees by the moving mechanism 163 and moved to the first inspection position 17a. At the first inspection position 17a, the electric wire with terminal W1 is handed over to the tilt correction portion 17 to be applied with the tilt correction.

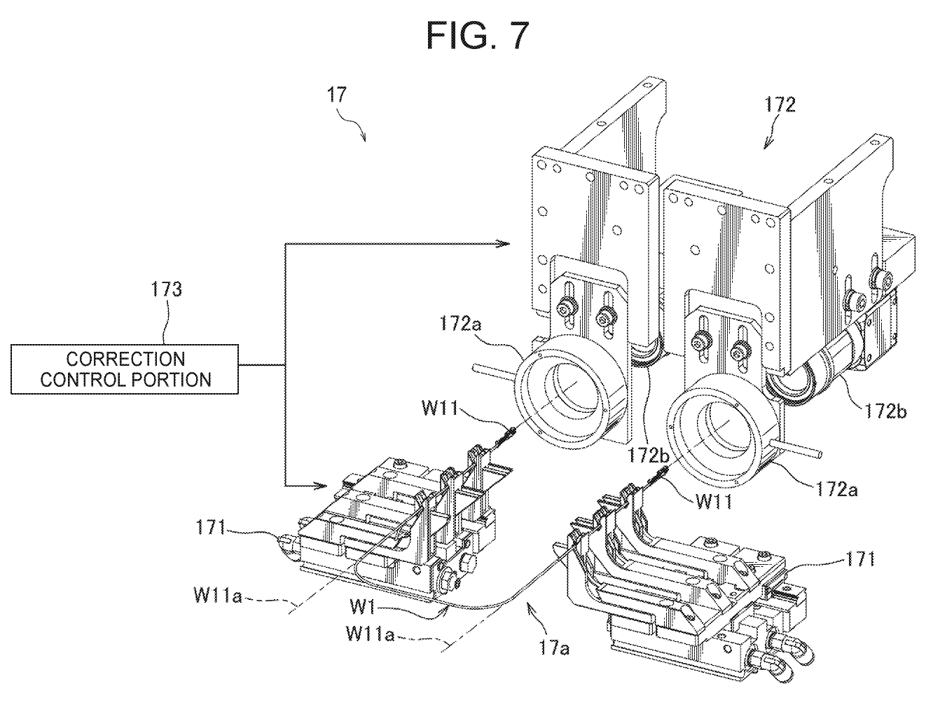

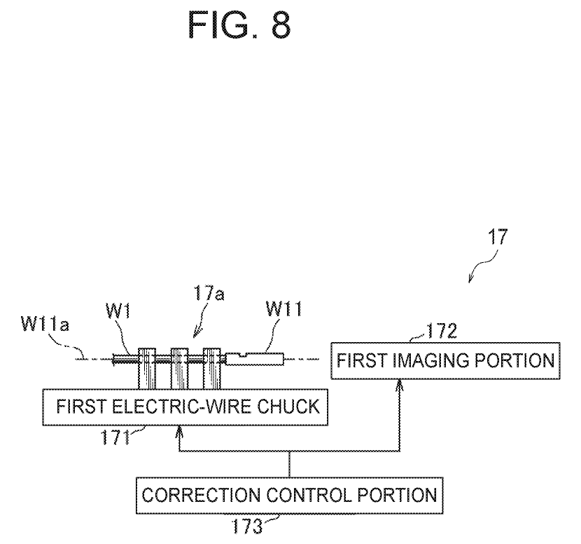

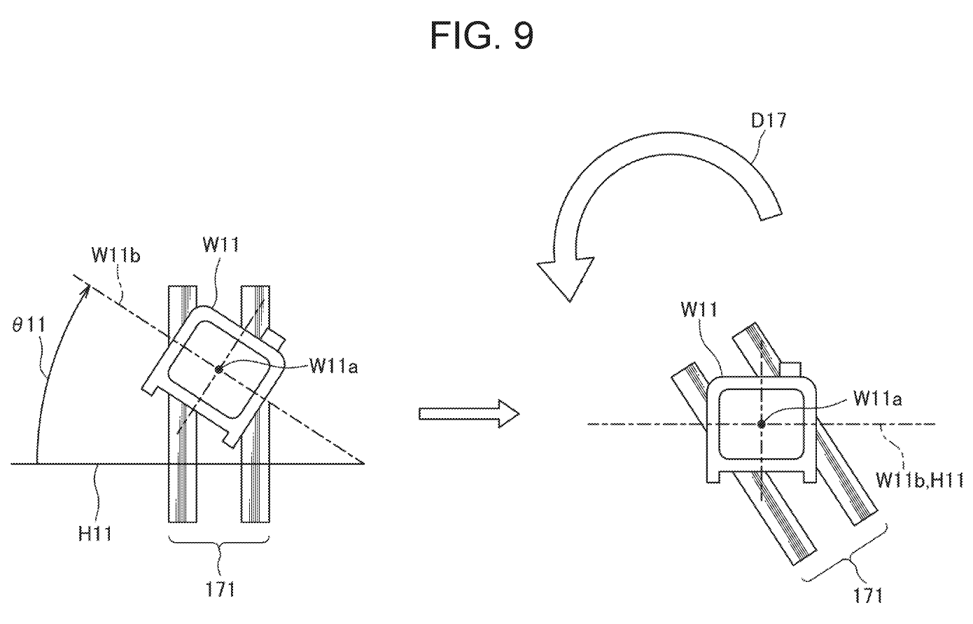

FIG. 7 is a view showing the tilt correction portion shown in FIG. 1 and FIG. 2 together with the electric wire with terminal as a correction target, FIG. 8 is a schematic side-view block diagram showing the tilt correction portion shown in FIG. 7. Then, FIG. 9 is a descriptive view for describing a tilt correction performed at the tilt correction portion shown in FIG. 7 and FIG. 8.

The tilt correction portion 17 is a portion for receiving the electric wire with terminal W1 from the first transporting portion 16 at the first inspection position 17a to perform the tilt correction. Here, the tilt correction refers to the processing of correcting the posture of the end portion terminal W11 around the axis W11a in the both end portions of the electric wire with terminal W1 that is picked up from the electric-wire holding tool 191. The tilt correction portion 17 includes a first electric-wire chuck 171, a first imaging portion 172, and a correction control portion 173. The first electric-wire chuck 171 is a pair of gripping mechanisms for gripping both end portions of the electric wire with terminal W1 received from the first transporting portion 16. The first inspection position 17a at the tilt correction portion 17 refers to the position for gripping the both end portions of the electric wire with terminal W1 by the first electric-wire chuck 171.

The first imaging portion 172 is a portion for imaging the end portion terminal W11 of each of both end portions of the electric wire with terminal W1 gripped by the first electric-wire chuck 171 from the front-end side of the corresponding end portion terminal W11. The first imaging portion 172 includes a pair of lights 172a for illuminating each end portion terminal W11 during the imaging and a pair of cameras 172b for imaging each illuminated end portion terminal W11. The correction control portion 173 detects a tilt angle θ11 around the axis W11a based on a front-end image of each end portion terminal W11 that is imaged by the first imaging portion 172. Here, the tilt angle θ11 is an angle of a horizontal axis W11b of the end portion terminal W11 with respect to the horizontal surface H11. As the correction control portion 173 detects the tilt angle θ11, in response to the detection result, it moves each end portion terminal W11 to correct the tilting by tilting each first electric-wire chuck 171 in a tilt correction direction D17 around the axis W11a so as to make the tilt angle θ11 to become zero. The electric wire with terminal W1 after the tilt correction is transported to a second inspection position 13a in the terminal insertion portion 13 by the second transporting portion 18.

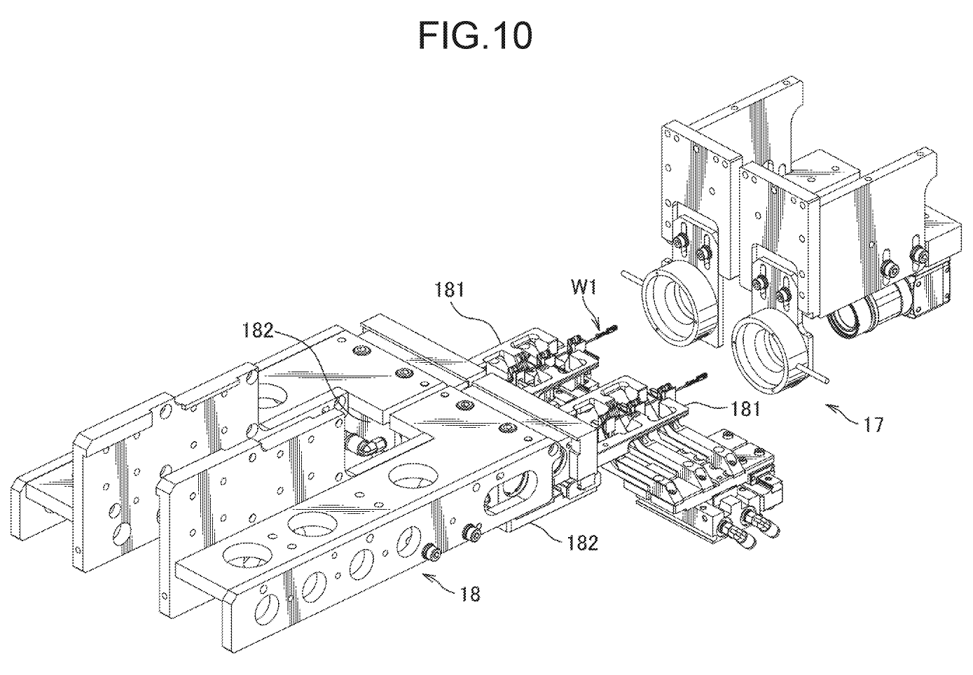

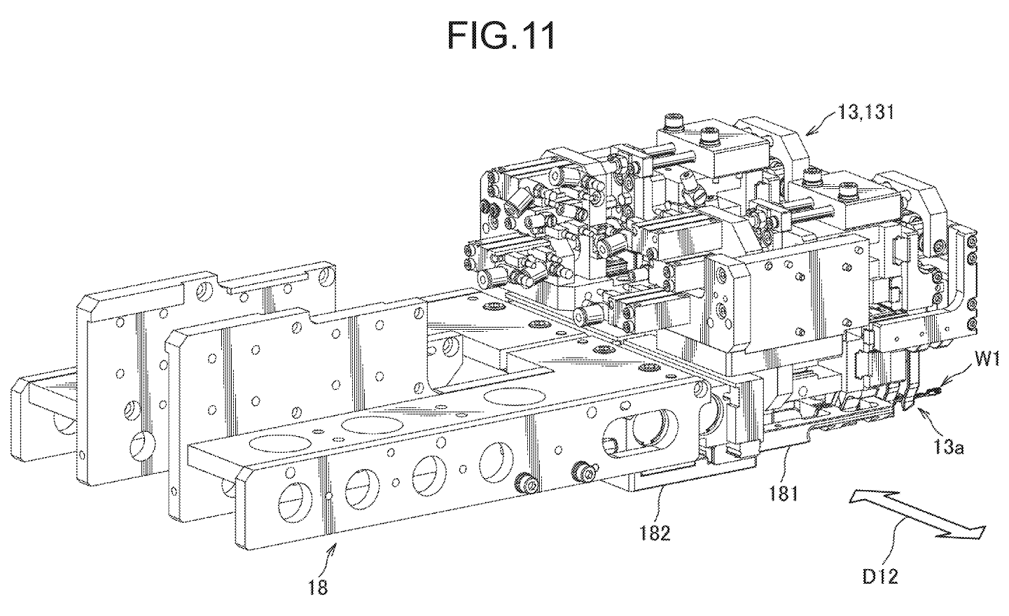

FIG. 10 is a view showing a second transporting portion shown in FIG. 1 and FIG. 2 together with the tilt correction portion as a transport source, and FIG. 11 is a view showing the second transporting portion shown in FIG. 10 together with part of the terminal insertion portion as the transport destination of the electric wire with terminal.

The second transporting portion 18 is a portion for receiving the electric wire with terminal W1 after the tilt correction from the tilt correction portion 17 and then transporting it to the second inspection position 13a in the terminal insertion portion 13. The second transporting portion 18 picks up both ends of the electric wire with terminal W1 while maintaining the U-shaped bending state in the tilt correction portion 17. The second transporting portion 18 includes a pair of gripping mechanisms 181 for gripping both end portions of the electric wire with terminal W1, a gripping driving mechanism 182 for driving each gripping mechanism 181, and a moving mechanism 183 for making the pair of gripping mechanisms 181 to the second inspection position 13a (see FIG. 1). Here, the terminal insertion portion 13 includes a second electric-wire chuck 131 described below for gripping the electric wire with terminal W1 received from the second transporting portion 18 and then inserting the end portion terminal W11 into the cavity C11 of the connector housing C1 on the housing pallet 11 at the terminal insertion position 123. This second electric-wire chuck 131 is provided at the terminal insertion position 123 to be movable in the longitudinal direction D12 of the housing pallet 11. Then, the second electric-wire chuck 131 receives the electric wire with terminal W1 at a position corresponding to the cavity C11 of the connector housing C1 as the insertion destination. The second inspection position 13a where the second transporting portion 18 transports the electric wire with terminal W1 to the terminal insertion portion 13 becomes the position of the second electric-wire chuck 131 corresponding to the cavity C11 of the connector housing C1 as the insertion destination.

The terminal insertion portion 13 receiving the electric wire with terminal W1 at the second inspection position 13a detects a positional deviation between the front-end position of the end portion terminal W11 and the position of the cavity C11 as the insertion destination in the connector housing C1. Then, the terminal insertion portion 13 moves at least one of the connector housing C1 and the electric wire with terminal W1 (in the present embodiment, the electric wire with terminal W1) to correct the positional deviation and insert the end portion terminal W11 after the correction of the positional deviation into the cavity C11 as the insertion destination.

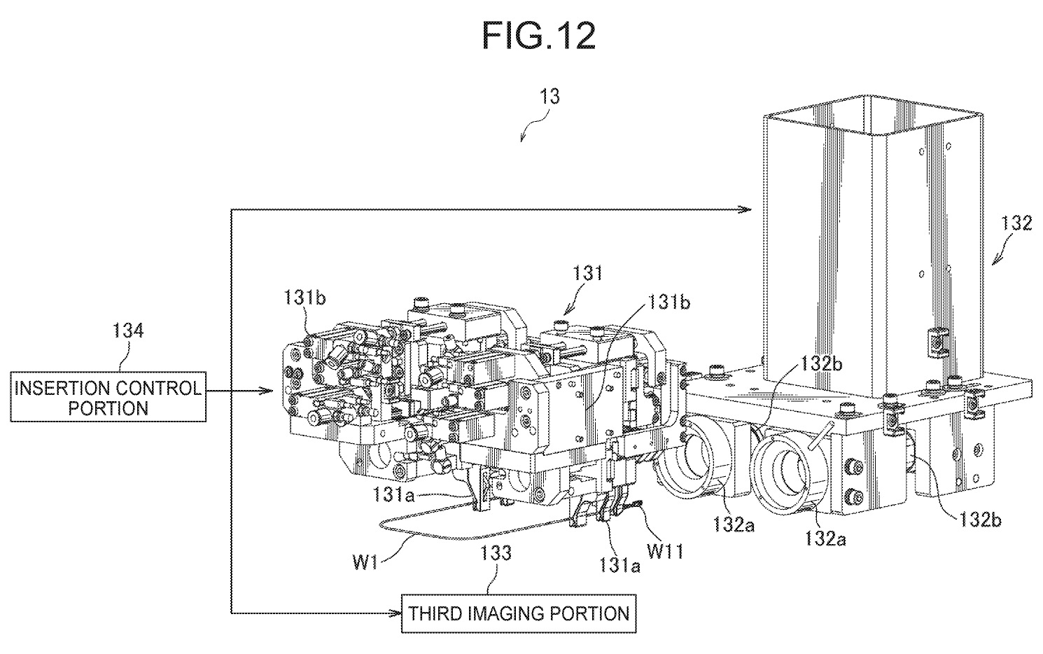

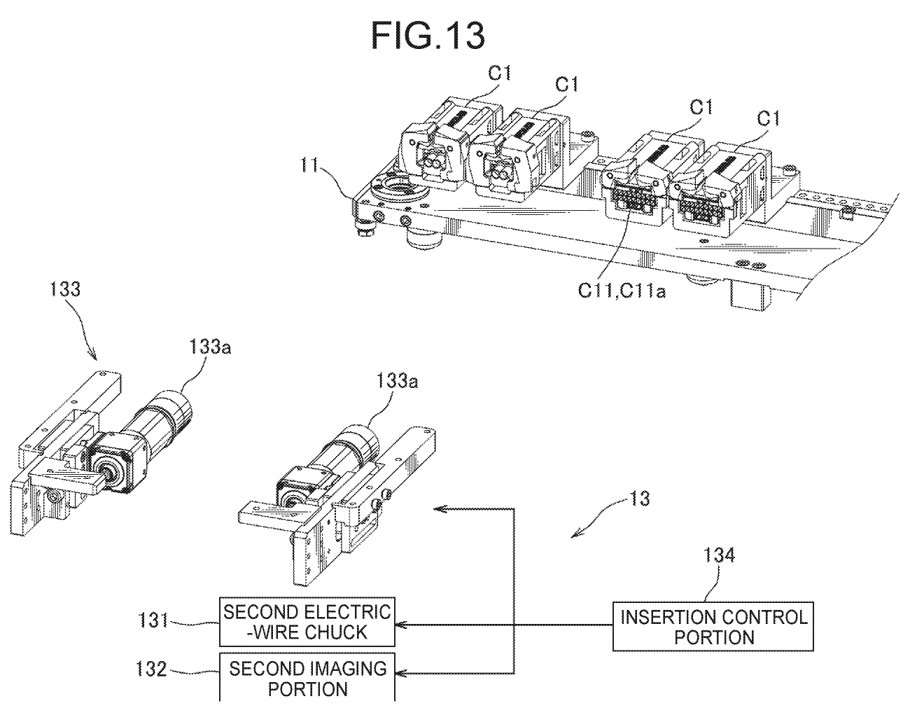

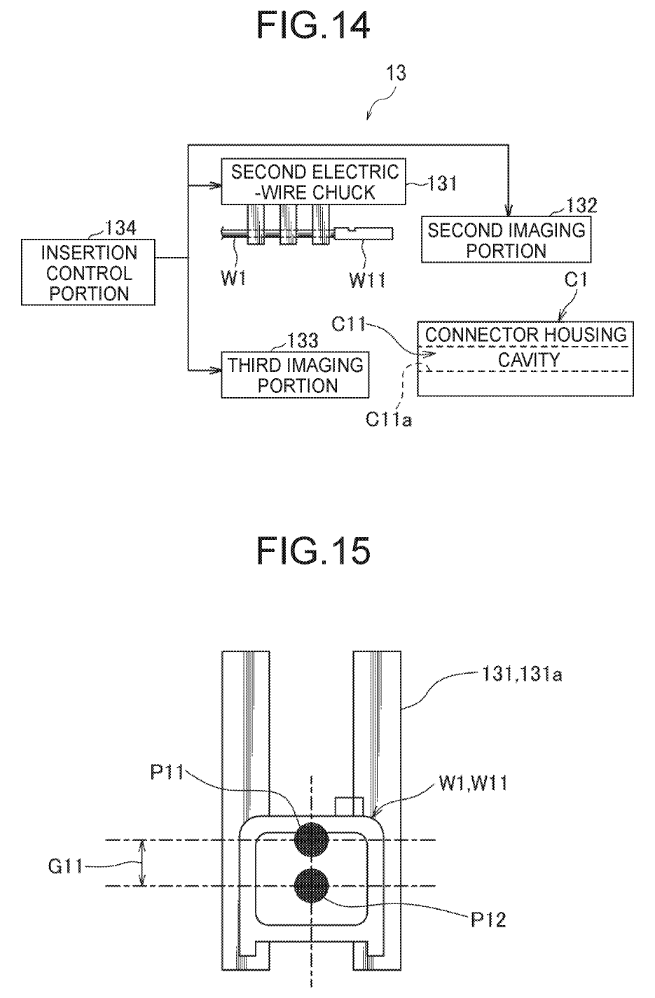

FIG. 12 is a view showing the terminal insertion portion shown in FIG. 1 and FIG. 2 while focusing on a detection function of a front-end position of an end portion terminal, FIG. 13 is a view showing the terminal insertion portion shown in FIG. 12 while focusing on a detection function of a position of the cavity as the insertion target. Also, FIG. 14 is a schematic side-view block diagram showing the terminal insertion portion shown in FIG. 12 and FIG. 13.

The terminal insertion portion 13 includes the second electric-wire chuck 131, a second imaging portion 132, a third imaging portion 133, and an insertion control portion 134. As described above, the second electric-wire chuck 131 is a portion moving to the second inspection position 13a in response to the cavity C11 of the connector housing C1 as the insertion destination to receive the electric wire with terminal W1 from the second transporting portion 18 and perform the terminal insertion. This second electric-wire chuck 131 includes the pair of gripping mechanisms 131a, the gripping driving mechanism 131b, and the moving mechanism 131c (see FIG. 1). The pair of gripping mechanisms 131a are a pair of mechanical portions for gripping the both end portions of the electric wire with terminal W1, and the gripping driving mechanism 131b is a mechanical portion for driving each gripping mechanism 131a. Then, the moving mechanism 131c (see FIG. 1) is a mechanical portion for making the pair of gripping mechanisms 131b to move to the second inspection position 13a.

The second imaging portion 132 is a portion for imaging the end portion terminal W11 of each of the both end portions of the electric wire with terminal W1 being gripped by the second electric-wire chuck 131 from the front-end side of the corresponding end portion terminal W11. The second imaging portion 132 includes a pair of lights 132a for illuminating each end portion terminal W11 during the imaging and a pair of cameras 132b for imaging each illuminated end portion terminal W11, and a moving mechanism 132c (see FIG. 1). The moving mechanism 132c becomes a mechanical portion for making the pair of lights 132a and the pair of cameras 132b to move to an opposite position facing the second electric-wire 131 that has moved to the second inspection position 13a.

The third imaging portion 133 is a portion for imaging a terminal insertion port C11a of the cavity C11 as the insertion destination in the connector housing C1 on the housing pallet 11. This third imaging portion 133 includes a pair of cameras 133a and moving mechanisms 133b (see FIG. 1) for each camera 133a. The pair of cameras 133a images the pair of cavities C11 as the insertion destination of the end portion terminal W11 of each of both end portions of the electric wire with terminal W1. The moving mechanism 133b makes each camera 133a to move to a position facing the cavity C11 as the insertion destination.

The insertion control portion 134 detects a positional deviation based on a front-end image of the end portion terminal W11 being imaged by the second imaging portion 132, and an image of the terminal insertion port C11a being imaged by the third imaging portion 133. This positional deviation is a positional deviation between the front-end position of the end portion terminal W11 and the position of the cavity C11 as the insertion target.

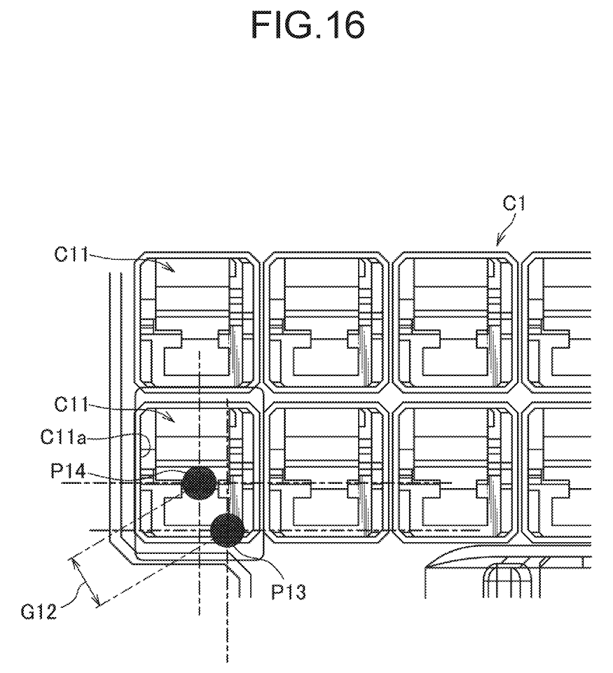

FIG. 15 is a schematic view showing a terminal-side positional deviation detected for the end portion terminal at an insertion control portion of the terminal insertion portion shown in FIG. 12 to FIG. 14. Also, FIG. 16 is a schematic view showing a cavity-side positional deviation detected for the cavity as the insertion target at the insertion control portion of the terminal insertion portion shown in FIG. 12 to FIG. 14.

At first, according to the present embodiment, regarding the pair of gripping mechanisms 131a in the second electric-wire chuck 131, an assumed front-end position of the end portion terminal W11 when the electric wire with terminal W1 is gripped by each gripping mechanism 131a is registered in the insertion control portion 134 as a registered terminal position P11. The insertion control portion 134 detects, from the front-end image of the end portion terminal W11 imaged by the second imaging portion 132, a terminal-side positional deviation G11 as a deviation between the pre-registered registered terminal position P11 and a front-end position P12 of the end portion terminal W11 in the image. Here, the registered terminal position P11 is a central position of the front end portion of the assumed end portion terminal W11 when viewed from the front end side, and the front-end position P12 is a central position of the front end portion of the end portion terminal W11 in the image. The insertion control portion 134 detects, regarding the front end of the end portion terminal W11, the deviation between these two central positions as the terminal-side positional deviation G11.

Also, in the insertion control portion 134, regarding a plurality of cavities C11 in each connector housing C1 on the housing pallet 11, a center of the terminal insertion port C11a in an ideal holding state is registered as a registered insertion position P13. Each registered insertion position P13 is a position being coincided with the registered terminal position P11 when the second electric-wire chuck 131 moves with each terminal insertion port C11a as the target. The insertion control portion 134 detects, from an image of the terminal insertion port C11a in an actual holding state that is imaged by the third imaging portion 133, a deviation between the registered insertion position P13 and an insertion port position P14 of the terminal insertion port C11a in the image as a cavity-side positional deviation G12. Here, the registered insertion position P13 is the central position of the terminal insertion port C11a in the ideal holding state, and the insertion port position P14 is a central position of the terminal insertion port C11a in the image. The insertion control portion 134 detects, regarding the terminal insertion port C11a, a deviation between the two central positions as the cavity-side positional deviation G12.

Then, the insertion control portion 134 detects a sum of the terminal-side positional deviation G11 and the cavity-side positional deviation G12 as a positional deviation between the front-end position of the end portion terminal W11 and the position of the cavity C11 as the insertion target. Here, the positional deviation refers to a positional deviation between the front-end position (central position) of the end portion terminal W11 and the position (central position) of the cavity C11 at the time of making the registered terminal position P11 to be coincided with the registered insertion position P13.

The insertion control portion 134 corrects the above-described positional deviation by moving at least one of the connector housing C1 and the electric wire with terminal W1 (in the present embodiment, the electric wire with terminal W1) and then inserting the end portion terminal W11 after correcting the positional deviation into the cavity C11 as the insertion target. At this time, the correction of positional deviation is performed by moving the second electric-wire chuck 131 up, down, left, and right toward the terminal insertion port C11a in response to the detection result of the positional deviation so as to make the end portion terminal W11 to move. Furthermore, according to the present embodiment, the insertion of the end portion terminal W11 after the correction of the positional deviation is performed following the procedures shown below.

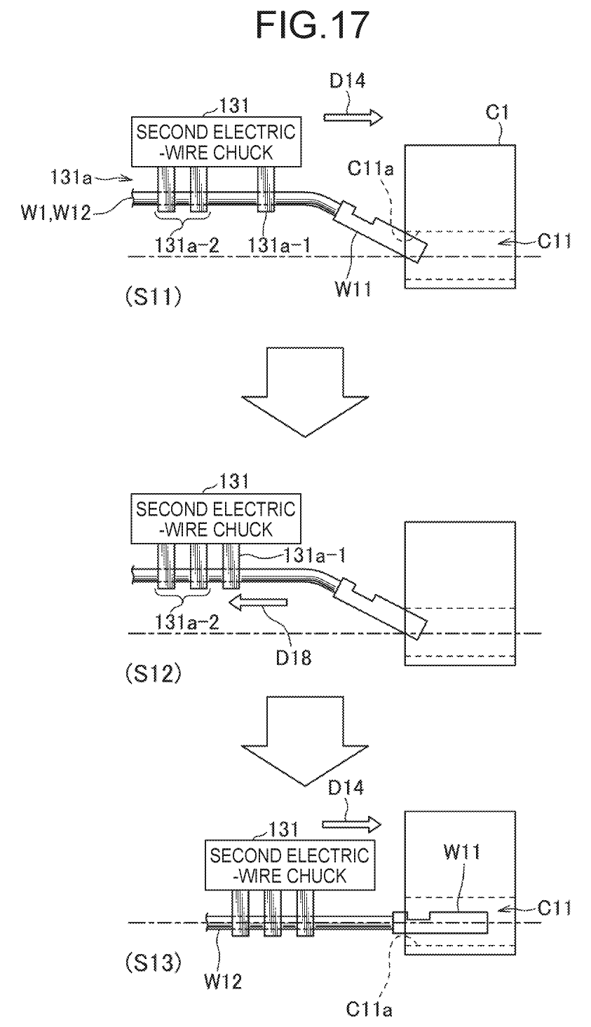

FIG. 17 is a schematic view showing procedures of inserting the end portion terminal after the positional deviation correction into the cavity as the insertion target in the terminal insertion portion shown in FIG. 12 to FIG. 14.

At first, according to the present embodiment, each of the pair of gripping mechanisms 131a in the second electric-wire chuck 131, includes a front chuck 131a-1 and a rear chuck 131a-2 as shown below. The front chuck 131a-1 is a portion in each gripping mechanism 131a for gripping the side of the end portion terminal W11 in the electric wire portion W12 of the electric wire with terminal W1. Among the three chuck portions of each gripping mechanism 131a, this front chuck 131a-1 is a chuck portion at the front side in the terminal insertion direction D14. Among the three chuck portions, the rear chuck portions 131a-2 are two chuck portions at the rear side in the terminal insertion direction D14, and configured to grip the portion at the rear side with respect to the front chuck 131a-1 in the terminal insertion direction D14. According to the present embodiment, the front chuck 131a-1 is movable in the front-rear direction along the terminal insertion direction D14, and the rear chuck 131a-2 becomes a fixed chuck being unable to move. Also, the front chuck 131a-1 is set with a default position being slightly apart from the rear chuck 131a-2 in the terminal insertion direction D14.

At the time of inserting the end portion terminal W11 into the cavity C11 as the insertion target in the connector housing C1, the insertion control portion 134 moves the second electric-wire chuck 131 as follows. At first, the second electric-wire chuck 131 gripping the electric wire with terminal W1, in the state where the front chuck 131a-1 is positioned at the default position, is moved in the terminal insertion direction D14 until the front end of the end portion terminal W11 after the correction of the positional deviation has been inserted into the terminal insertion port C11a (Step S11). Then, the insertion control portion 134 releases the gripping by the front chuck 131a-1, and then makes it to retract for a predetermined distance in a retraction direction D18 toward the side of the rear chuck 131a-2, and makes it to grip again (Step S12). Thereafter, the insertion control portion 134 inserts the end portion terminal W11 into the cavity C11 as the insertion target by moving the second electric-wire chuck 131 toward the terminal insertion port C11a in the terminal insertion direction D14 (Step S13).

Also, the insertion control portion 134, when moving the second electric-wire chuck 131 toward the terminal insertion port C11a again, moves the second wire chuck 131 toward the terminal insertion opening C11a while aligning the electric wire portion W12 of the electric wire with terminal W1 with respect to the terminal insertion opening C11a. As schematically shown in FIG. 17, there may be a case in which the electric wire with terminal W1 is held by the second electric-wire chuck 131 in a state in which the end portion terminal W11 hangs down due to its own weight or the like. In the step of the above-described Step S11, the correction of the positional deviation of the front-end position of the end portion terminal W11 in such hanging down state is performed, and the front-end portion thereof is in the state of being inserted into the terminal insertion port C11a. In this step, the electric wire portion W12 of the electric wire with terminal W1 is deviated upward from the terminal insertion port C11a by an amount of the hanging down of the end portion terminal W11. In the Step S13, in order to correct the deviation of this electric wire portion W12, the insertion control portion 134 moves the second electric-wire chuck 131 downward to perform the alignment of the electric wire portion W12 with respect to the terminal insertion port C11a. Here, in the correction of positional deviation due to the terminal-side positional deviation G11 and the cavity-side positional deviation G12 as described by referring to FIG. 15 and FIG. 16, the correction amount in the up-down direction is used to correct the positional deviation caused by the hanging down of the end portion terminal W11 described above. Therefore, in the state where the front end of the end portion terminal W11 is inserted into the terminal insertion port C11a in the Step S11, the electric wire portion W12 is deviated upward with respect to the terminal insertion port C11a by an amount corresponding to the correction amount in the up-down direction. Therefore, in the Step S13, in the correction of the positional deviation due to the terminal-side positional deviation G11 and the cavity-side positional deviation G12, by returning the correction in the up-down direction to the original state thereof, the alignment of the end portion terminal W11 and the electric wire portion W12 are performed so as to be in a straight state with respect to the cavity C11. The insertion control portion 134, in the Step S13, inserts the end portion terminal W11 into the cavity C11 while performing such alignment.

In the terminal insertion portion 13, regarding each of the end portion terminals W11 at both end portions of the electric wire with terminal W1, the terminal insertion is performed while performing correction of the positional deviation with the cavity C11a as the insertion target in the connector housing C11 corresponding to each end portion terminal W11. Since such correction of positional deviation and terminal insertion are performed individually for each end portion terminal W11, the correction of positional deviation and terminal insertion are performed twice for one electric wire with terminal W1.

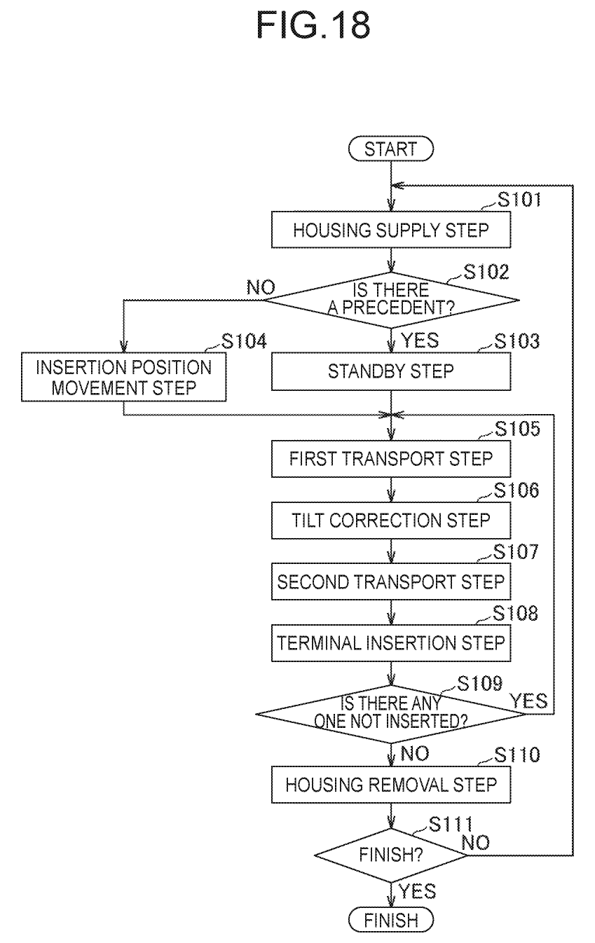

Next, a terminal insertion method performed by the terminal insertion unit 1 according to the present embodiment will be described by referring to FIG. 1 to FIG. 17 as described above and the following FIG. 18 with some paragraphs being redundant with the description shown above.

FIG. 18 is a flowchart schematically showing a flow of processing of a terminal insertion method executed in the terminal insertion unit 1 shown in FIG. 1 to FIG. 17.

The processing of the terminal insertion method shown in the flowchart in this FIG. 18 starts when the electric-wire holding tool 191, to which the electric wires with terminal W1 are set, is placed on the holding tool placement portion 19 by the operator Y1 and then a predetermined start operation is received. Once the processing starts, a housing supply Step S101 is performed with respect to one housing pallet 11. According to the housing supply Step S101, the one housing pallet 11 is positioned at the housing supply position 121 in the circulation route R11, and the connector housing C1 is supplied to be held by the housing holder 112. Thereafter, a presence or absence determination S102 of the housing pallet 11 regarding whether or not a precedent one is positioned at the terminal insertion position 123 is performed. In a case in which there is a precedent pallet (YES determination), a standby Step S103, in which the housing pallet 11 as the supplied housing is positioned at the standby position 122, it is made to standby until the terminal insertion position 123 becomes available, and after the standby, the housing pallet 11 is positioned at the terminal insertion position 123, is performed. In a case in which there is not any precedent pallet (NO determination), an insertion position movement Step S104 in which the housing pallet 11 as the supplied housing is immediately positioned at the terminal insertion position 123, is performed. During the step immediately after the start, there is not any precedent pallet such that the insertion position movement Step S104 is executed.

When the one housing pallet 11 is positioned at the terminal insertion position 123, a first transport Step S105 to a terminal insertion Step S108 are carried out for the connector housing C1 on this housing pallet 11. According to the first transport Step S105, the first transporting portion 16 grips one electric wire with terminal W1 in the electric wire holding tool 191 and transports it to the first inspection position 17a. According to the tilt correction Step S106, the electric wire with terminal W1 is received by the first electric-wire chuck 171 of the tilt correction portion 17 from the first transporting portion 16 at the first inspection position 17a and then gripped. Furthermore, in the tilt correction portion 17, regarding the posture of the end portion terminal W11 around the axis W11a, a tilt from the insertion posture into the cavity C11 is detected. Thereafter, the tilt correction portion 17 moves the end portion terminal W11 to correct the tilting by tilting the first electric-wire chuck 171 around the axis W11a in response to the detection result. According to the second transport Step S107, the electric wire with terminal W1 after the tilt correction is received by the second transporting portion 18 from the tilt correction portion 17, and transported to the second inspection position 13a in the terminal insertion portion 13. According to the terminal insertion Step S108, the electric wire with terminal W1 is received by the second electric-wire chuck 131 in the terminal insertion portion 13 from the second transporting portion 18 at the second inspection position 13a. Furthermore, the positional deviation between the front-end position of the end portion terminal W11 and the position of the cavity C11 in the connector housing C1 as the insertion target is detected. Then, the positional deviation is corrected by moving the second electric-wire chuck 131 toward the terminal insertion port C11a, and the second electric-wire chuck 131 is moved toward the terminal insertion port C11a such that the end portion terminal W11 after the correction of the positional deviation is inserted into the cavity C11 as the insertion target. The first transport Step S105 to the terminal insertion Step S108 is performed with respect to the one electric wire with terminal W1 that is held by the electric wire holding tool 191.

Thereafter, subsequent to the terminal insertion Step S108, a presence or absence determination S109 regarding a non-inserted electric wire with terminal W1 in the electric wire holding tool 191 is executed. In a case where there is a non-inserted electric wire with terminal W1 (YES determination), it will be returned to the first transport Step S105, and the following steps will be repeated. In a case in where all the terminal insertions have been finished and there is not any non-inserted electric wire with terminal W1 (NO determination), a housing removal Step S110 is executed. According to the housing removal Step S110, one housing pallet 11 after the terminal insertion is positioned at the housing removal position 124, and the connector housing C1 is removed from the housing holder 112 from the operator Y1. The connector-attached electric wire bundle 2 as the output in this housing removal Step S110 is removed.

Thereafter, a decision S111 on whether or not to finish the processing with respect to the housing pallet 11 is performed, and in a case where the processing is finished (YES), the processing is finished. In a case of continuing the processing (NO), the processing is returned to the housing supply Step S101, and the following processing is repeated. Here, in the flowchart shown in FIG. 18, focusing on one housing pallet 11 among the three housing pallets 11, a flow of the processing of the terminal insertion method applied with respect to the housing pallet 11 is shown. According to the present embodiment, this processing is performed with respect to each of the three housing pallets 11. Then, for each housing pallet 11, the housing supply Step S101, from the first transport Step S105 to the terminal insertion Step S108, and the housing removal Step S110 are performed while suitably inserting the standby Step S103 therebetween and parallelly moving the housing pallet 11.

According to the termina insertion unit 1 and the terminal insertion method in the above-described embodiment, the following effects can be achieved due to the configuration relating to the circulated movement of the housing pallet 11 and the configuration for performing various corrections and transporting the electric wire with terminal W1 to perform the terminal insertion.

At first, the effect according to the configuration relating to the circulated movement of the housing pallet 11 will be described. According to such configuration, it is possible for the housing pallet 11 having the housing holder 112 to move along the circulation route R11 via the housing supply position 121, the standby position 122, the terminal insertion position 123, and the housing removal position 124. Then, when the terminal insertion of one housing pallet 11 is finished, another housing pallet 11 in which the connector housing C1 as the next terminal insertion target is held by the housing holder 112 is standby at the standby position 122. Accordingly, when the housing pallet 11 after the terminal insertion has been moved to the housing removal position 124 for the removal of the connector housing C11, it is possible to move the housing pallet 11 at the standby position 122 to the terminal insertion portion 123 to immediately perform the terminal insertion. In this manner, according to the present embodiment, it is possible to efficiently repeat the terminal insertion with respect to the connector housing C1. Also, according to the present embodiment, considering that there are two or more than two (according to the present embodiment, there are three) housing pallets 11 provided, the above-described each step of the terminal insertion method is performed parallelly such that it is possible to reduce the cycle time. According to this configuration, it is possible to perform the terminal insertion with respect to the connector housing C1 more efficiently.

Here, according to the present embodiment, there are three housing pallets 11 provided to move along the circulation route R11 while leaving one among the housing supply position 121, the standby position 122, the terminal insertion portion 123, and the housing removal position 124 to be vacant. According to such configuration, even if there is a housing pallet 11 left at the terminal insertion position 123 and the housing removal position 124, it is possible to utilize the vacant space in the circulation route R11 to move other two housing pallets 11 to perform the housing supply. According to the above-described configuration, it is possible to repeat the terminal insertion with respect to the connector housing C1 more efficiently.

Also, according to the present embodiment, there is a housing supply portion 15 for supplying the connector housing C1 to the housing pallet 11 positioned at the housing supply position 121 to be held by the housing holder 112. According to the configuration, it is possible to make the housing supply itself at the housing supply position 121 to be efficiently performed.

Also, according to the present embodiment, the housing holder 112 is the configuration of holding the connector housing C1 by embracing it with the pair of arms 112a being able to open and close. The pair of arms 112a are opened at the housing supply position 121, and the housing supply portion 15 supplies the connector housing C1 to the housing holder 112 in the state where the pair of arms 112a are opened. According to this configuration, it is possible to perform the supply and holding of the connector housing C1 to the housing holder 112, and further the removal thereof at the housing removal position 124 with good operability.

Also, according to the present embodiment, various types of housing holders 112 corresponding to each size are attached to the housing pallet 11 so as to be able to hold various types of connector housings C1 whose size is different from each other. According to this configuration, the terminal insertion is possible with respect to various types of connector housings C1 so as to improve the versatility regarding the terminal insertion.

Also, according to the present embodiment, the pallet holding frame 12 is placed on the predetermined installation surface with the ground at the lower side. Then, the pallet holding frame 12 holds the housing pallet 11 so as to be movable along a circular route as the circulation route R11 on the surface along the installation surface. According to the configuration, when the operator Y1 manually performs the removal of the connector housing C1 at the housing removal position 124, it is possible to access the circulation route R11 on the surface along the installation surface from the upper side. Then, due to the access in this manner, it is possible for the operator Y1 to perform the removal of the connector housing C1 with good operability.

Also, according to the present embodiment, the housing removal position 124 becomes the position to which the operator Y1 faces, and the terminal insertion position 123 is the position being adjacent to the housing removal position 124 in the left-right direction D11 viewed from the operator Y1. Also, the housing supply position 121 becomes the position being apart toward the deep side from the housing removal position 124 in the depth direction D15 viewed from the operator Y1. Then, the standby position 122 becomes the position being adjacent to the housing supply position 121 in the left-right direction D11 while being apart toward the deep side from the terminal insertion position 123 in the depth direction D15. According to the configuration, it is possible for the operator Y1 to access the housing removal position 124 facing him/her with good operability to remove the connector housing C1. Also, the terminal insertion in prior to this operation is performed at the terminal insertion position 123 being adjacent to the housing removal position 124 in the left-right direction D11 viewed from the operator Y1 such that it is possible to visually confirm the progress thereof and perform the preparation of the removal operation.

Also, according to the present embodiment, the housing pallet 11 includes the strip rod-shaped pallet main body 111 positioned at the housing removal position 124 to extend in the left-right direction D11. The housing holders 112 are attached in the longitudinal direction D12 of the pallet main body 111 in the state of being arranged in a line. The movement of the housing pallet 11 from the terminal insertion position 123 to the housing removal position 124 and the movement of the housing pallet 11 from the housing supply position 121 to the standby position 122 are performed along the longitudinal direction D12 of the pallet main body 111. Also, the movement of the housing pallet 11 from the housing removal position 124 to the housing supply position 121 and the movement of the housing pallet 11 from the standby position 122 to the terminal insertion position 123 are performed along the depth direction D15 (intersecting direction) intersecting the longitudinal direction D12. According to the configuration, the housing holders 112 facing the operator Y1 are in the state of being arranged in a line such that it is possible to further improve the operability at the housing removal position 124 and the visual ability to the progress of the terminal insertion at the terminal insertion position 123.

Also, according to the present embodiment, the housing holder 112 is attached to the pallet main body 111 with the attachment position is changeable in the longitudinal direction D12. According to the configuration, for example, the device can be effectively used when manufacturing a wire harness having a branch shape and a connector provided at each branch end portion. That is, according to the above-described configuration, it is possible to perform the device usage to arrange the connector housing C1 in response to the branch shape, perform the terminal insertion with respect to each connector housing C1 and the like.

Also, according to the present embodiment, the housing holder 112 holds the connector housing C1 such that the rear side thereof from which the end portion terminal W11 is inserted in the connector housing C1 and the electric wire with terminal W1 extends is facing the side of the operator Y1 at the housing removal position 124. According to the configuration, in the state in which the electric wire extends toward the operator Y1 from the rear side, the connector housing C1 where the terminal insertion is finished is arranged at the housing removal position 124. Due to such arrangement, it is possible for the operator Y1 to hold the electric wire with good operability and perform the removal of the connector housing C1.

Next, the effects due to the configuration for transporting the electric wire with terminal W1 while performing various corrections and then performing the terminal insertion will be described. According to this configuration, the electric wire with terminal W1 is handed over from the first transporting portion 16 to the second transporting portion 18 while receiving the tilting correction of the end portion terminal W11 during the procedure. Furthermore, the electric wire with terminal W1 is handed over from this second transporting portion 18 to the terminal insertion portion 13, and at the terminal insertion portion 13, the correction of the positional deviation with respect to the cavity C11 as the insertion target is applied thereto. Due to this series of processing, the obstacles against the smooth terminal insertion are removed from both the gripping state of the electric wire with terminal W1 at the first transporting portion 16 and the relative positional relationship between the end portion terminal W11 and the cavity C11 at the time of handing over at the terminal insertion portion 13. Accordingly, it is unnecessary to perform any strict position management in the gripping of the electric wire with terminal W1 at the first transporting portion 16 and the holding of the connector housing C1 at the housing holder 112 of the housing pallet 11. In this manner, according to the present embodiment, the end portion terminal W11 of the electric wire with terminal W1 can be smoothly inserted into the cavity C11 of the connector housing C1 while reducing the burden on the operator.

Here, according to the present embodiment, the tilt correction portion 17 includes the first electric-wire chuck 171, the first imaging portion 172 for imaging the end portion terminal W11 from the front-end side, and the correction control portion 173. The correction control portion 173 detects the tilting based on the imaged front-end images, and moves the end portion terminal W11 to correct the tilting by tilting the first electric-wire chuck 171 around the axis W11a in response to the detection result. According to this configuration, due to the tilting detection based on the front-end images at the first imaging portion 172, and the tilting of the first electric-wire chuck 171 in response to the detection result, it is possible to correct the tilting of the end portion terminal W11 effectively and in high precision.

Also, according to the present embodiment, the terminal insertion portion 13 includes the second electric-wire chuck 131, the second imaging portion 132 for imaging the end portion terminal W11 from the front-end side, the third imaging portion 133 for imaging the terminal insertion port C11a in the cavity C11 as the insertion target, and the insertion control portion 134. The insertion control portion 134 detects the positional deviation based on the front-end image of the end portion terminal W11 and the image of the terminal insertion port C11a. Then, the insertion control portion 134 moves the end portion terminal W11 to correct the positional deviation by moving the second electric-wire chuck 131 up, down, left, and right toward the terminal insertion port C11a in response to the detection result. Furthermore, the insertion control portion 134 inserts the end portion terminal W11 into the cavity C11 as the insertion target by moving the second electric-wire chuck 131 toward the terminal insertion port C11a together with the correction of the positional deviation. According to this configuration, due to the detection of the positional deviation based on the front-end image and the image of the terminal insertion port C11a, and the movement of the second electric-wire chuck 131 in response to the detection result, it is possible to correct the positional deviation effectively and in high precision and insert the end portion terminal W11 into the cavity C11.

Also, according to the present embodiment, the insertion control portion 134 detects, from the front-end image of the end portion terminal W11, the terminal-side position deviation G11 as the deviation between the registered terminal position P11 and the front-end position P12 of the end portion terminal W11 in the image. Furthermore, the insertion control portion 134 detects, from the image of the terminal insertion port C11a, the cavity-side positional deviation G12 as the deviation between the registered insertion position P13 and the insertion port position P14 of the terminal insertion port C11a in the image. Then, the insertion control portion 134 detects the sum of the terminal-side positional deviation G11 and the cavity-side positional deviation G12 as the positional deviation between the end portion terminal W11 and the terminal insertion port C11a. According to this configuration, by detecting and summing each of the terminal-side positional deviation G11 and the cavity-side positional deviation G12, it is possible to detect the positional deviation between the end portion terminal W11 and the terminal insertion port C11a in high precision.

Also, according to the present embodiment, the second electric-wire chuck 131 includes the front chuck 131a-1 and the rear chuck 131a-2. The insertion control portion 134, at first, moves the second electric-wire chuck 131 until the front end of the end portion terminal W11 after the correction of the positional deviation is inserted into the terminal insertion port C11a. Thereafter, the insertion control portion 134 releases the gripping by the front chuck 131a-1 and retracts it for the predetermined distance only toward the side of the rear chuck 131a-2, and then makes it to grip again. Then, the insertion control portion 134 moves the second electric-wire chuck 131 again toward the terminal insertion port C11a so as to insert the end portion terminal W11 into the cavity C11 as the insertion target. According to this configuration, by bringing the front chuck 131a-1 as close as possible to the end portion terminal W11 to grip it, the front end of the end portion terminal W11 can be inserted into the terminal insertion port C11a in a high precision. Then, thereafter, it is possible to retract the front chuck 131a-1 so as to secure the insertion stroke, and effectively insert the end portion terminal W11 into the cavity C11.

Also, according to the present embodiment, the insertion control portion 134, when it moves the second electric-wire chuck 131 toward the terminal insertion port C11a again, performs the alignment of the electric-wire portion W12 while moving the second electric-wire chuck 131. According to the configuration, by performing the alignment of the electric wire portion W12, it is possible to insert the end portion terminal W11 into the cavity C11 more smoothly.

Also, according to the present embodiment, the first transporting portion 16 grips both ends of the electric wire with terminal W1 to transport it to the first inspection position 17a, and the tilt correction portion 17 corrects the tilting with respect to each end portion terminals W11 of both ends of the electric wire with terminal W1. The second transporting portion 18 grips both ends of the electric wire with terminal W1 after the tilt correction to transport it to the second inspection position 13a. The terminal insertion portion 13, with respect to each end portion terminal W11 of both ends of the electric wire with terminal W1, corrects the positional deviation with the cavity C11 in the corresponding connector housing C1 as the insertion target and performs the terminal insertion. According to the configuration, the end portion terminals W11 of both ends of the electric wire with terminal W1 are transported to the terminal insertion portion 13 while receiving the tile correction together. Regarding the terminal insertion portion 13, each of the end portion terminals W11 of both ends is inserted into the cavity C11 of the corresponding connector housing C1 while receiving the correction of the positional deviation. Due to such series of processing, with respect to the end portion terminals W11 of both ends of the electric wire with terminal W1, it is possible to efficiently perform the smooth insertion to the cavity C11.

Also, according to the present embodiment, in the housing pallet 11, the electric-wire temporary holder 113 for temporarily holding one or more non-inserted electric wires with terminal W2 is provided in adjacent to the housing holder 112. The terminal insertion portion 13, without performing the detection of the positional deviation and the correction, transports the non-inserted electric wire with terminal W2 to the electric-wire temporary holder 113 to be held. According to this configuration, even with respect to the non-inserted electric wire with terminal W2, it is suitable that they can be processed together with the electric wires with terminal W1 wherein the end portion terminals W11 are inserted into the cavity C11.

Also, according to the present embodiment, the electric-wire temporary holder 113 is a configuration in which one or more electric-wire gripping portions 113b for gripping the electric wire portion W22 of the non-inserted electric wire with terminal W2 by the pair of U-shaped leaf spring members 113b-1 is provided. The terminal insertion portion 13 transports the non-inserted electric wire with terminal W2 so as to make the location near the non-inserted terminal W21 in the electric wire portion W22 to be gripped by the electric-wire gripping portion 113b. According to this configuration, by making the electric wire portion W12 in the non-inserted electric wire with terminal W2 to be gripped by the pair of U-shaped leaf spring members 113b-1 in the electric-wire gripping portion 113b, it is possible to hold the non-inserted electric wire with terminal W2 by the electric-wire temporary holder 113 with a high holding strength.

Also, the above-described embodiment is made for showing a representative embodiment of the terminal insertion unit and the terminal insertion method. The terminal insertion unit and the terminal insertion method are not limited thereto, and various modifications can be implemented.

For example, in the above-described embodiment, as an example of the terminal insertion unit and the terminal insertion method, the terminal insertion unit 1 and the terminal insertion method for manufacturing the connector-attached electric wire bundle 2 configuring at least part of the wire harness mounted and routed in the vehicle or the like are shown. However, the terminal insertion unit and the terminal insertion method are not limited thereto, the specific application targets are not particularly limited.

Also, according to the above-described embodiment, as an example of the terminal insertion unit and the terminal insertion method, the terminal insertion unit 1 in which the specific shapes and configurations of each configuration element and the terminal insertion method using this terminal insertion unit 1 are shown in FIG. 1 and FIG. 2. However, the terminal insertion unit and the terminal insertion method are not limited thereto, the specific shapes and configurations of the configuration elements in the terminal insertion unit are not particularly limited.

Also, according to the above-described embodiment, as an example of the terminal insertion unit and the terminal insertion method, the terminal insertion unit 1 and the terminal insertion method to pick up the electric wire with terminal W1, from the electric-wire holding tool 191 that is transported to the holding tool placement portion 19 by the operator Y1, to perform the terminal insertion are shown. However, the terminal insertion unit and the terminal insertion method are not limited thereto. The terminal insertion unit and the terminal insertion method may be a unit and a method that receives the electric wire with terminal directly from the manufacturing device for the electric wire with terminal and performing the terminal insertion without the necessity of the transport of the electric-wire holding tool 191 by the operator Y1 or the like.

### [REFERENCE SIGNS LIST]

1 terminal insertion unit

2 connector-attached electric-wire bundle

11 housing pallet

12 pallet holding frame

12a top plate portion

13 terminal insertion portion

13a second inspection position

14 pallet driving portion

15 housing supply portion

16 first transporting portion

17 tilt correction portion

17a first inspection position

18 second transporting portion

19 holding tool placement portion

111 pallet main body

112 housing holder

112a arm

113 electric-wire temporary holder

113b electric-wire clamping portion

113b-1 U-shaped leaf spring member

121 housing supply position

122 standby position

123 terminal insertion position

124 housing removal position

131 second electric-wire chuck

131a, 161, 181 gripping mechanism

131a-1 front chuck

131a-2 rear chuck

131b, 162, 182 gripping driving mechanism

131c, 132c, 133b, 163, 183 moving mechanism

132 second imaging portion

132a, 172a light

132b, 133a, 172b camera

133 third imaging portion

134 insertion control portion

171 first electric-wire chuck

172 first imaging portion

172a light

173 correction control portion

191 electric-wire holding tool

191a holding slit

C1 connector housing

C11 cavity

C11a terminal insertion port

D11 left-right direction

D12 longitudinal direction

D13 open-close direction

D14 terminal insertion direction

D15 depth direction

D16 rod length direction

D17 correction direction

G11 terminal-side positional deviation

G12 cavity-side positional deviation

H11 horizontal surface

P11 registered terminal position

P12 front-end position

P13 registered insertion portion

P14 insertion port position

R11 circulation route

S101 housing supply step

S102, S109 presence or absence determination

S103 standby step

S104 insertion position movement step

S105 first transport step

S106 tilt correction step

S107 second transport step

S108 terminal insertion step

S110 housing removal step

S111 decision on whether or not to finish

W1 electric wire with terminal

W2 non-inserted electric wire with terminal

W11 end portion terminal

W11a axis

W11b horizontal axis

W12, W22 electric wire portion

W21 non-inserted terminal

Y1 operator

θ11 tilt angle

What is claimed is:

1. A terminal insertion unit, comprising:
two and more housing pallets to which one and more housing holders are attached, the housing holder being able to hold a connector housing in which multiple cavities into which end portion terminals of electric wires with terminal are insertable respectively;
a pallet holding frame configured to hold two and more housing pallets in a state of being able to move along a circulation route from a housing supply position where the connector housing is supplied to be held by the housing holder, a standby position where the housing pallets temporarily standby after housing holding, a terminal insertion position where the end portion terminals of the electric wires with terminal are inserted into the cavities of the connector housings, and a housing removal position where the connector housings after terminal insertion are removed from the housing holders in this sequence, and to return to the housing supply position after housing removal;
a terminal insertion portion configured to insert the end portion terminals into the cavities of the connector housings in the housing pallets positioned at the terminal insertion position; and
a pallet driving portion configured to make two and more housing pallets to move along the circulation route so as to make, during a period from one of the housing pallet receives the housing supply at the housing supply position until the terminal insertion at the terminal insertion position is finished, other housing pallets to standby at the standby position after the housing supply,
wherein the pallet driving portion moves the housing pallets around the circulation route only by four straight movements, including a straight movement from the housing removal position to the housing supply position, a straight movement from the housing supply position to the standby position, a straight movement from the standby position to the terminal insertion position, and a straight movement from the terminal insertion position to the housing removal position.

2. The terminal insertion unit according to claim 1, wherein three of the housing pallets are provided so as to move along the circulation route with one location among the housing supply position, the standby position, the terminal insertion position, and the housing removal position is vacant.

3. The terminal insertion unit according to claim 1, further comprising a housing supply portion configured to stock the connector housings and supply the connector housings to the housing pallets positioned at the housing supply position so as to be held by the housing holder.

4. The terminal insertion unit according to claim 1, wherein various types of the housing holders corresponding to various sizes are attached to the housing pallets so as to be able to hold various types of connector housings having different sizes with each other.

5. The terminal insertion unit according to claim 1, wherein the pallet holding frame is a configuration being placed on an installation surface with the ground at a lower side, and configured to hold the housing pallets so as to be movable along an annular route on a surface along the installation surface.

6. The terminal insertion unit according to claim 5,
wherein removal of the connector housing from the housing holder in the housing pallet is performed by a manual operation of an operator, and
the circulation route, as the annular route on the surface, is a route of connecting the housing removal position facing the operator on the surface, the terminal insertion position being adjacent to the housing removal position on the surface in a left-right direction when viewed from the operator, the housing supply position being apart from the housing removal position on the surface toward a deep side in a depth direction when viewed from the operator, and the standby position being adjacent to the housing supply position in the left-right direction while being apart from the terminal insertion position toward the deep side in the depth direction, in a sequence as from the housing supply position to the standby position, to the terminal insertion position, and to the housing removal position in this sequence.

7. The terminal insertion unit according to claim 6,
wherein the housing pallet is a configuration of attaching, on a rod-shaped pallet main body positioned to extend in the left-right direction at the housing removal position, one or more housing holders in a state of being arranged in a line along a longitudinal direction of the pallet main body,
a movement of the housing pallet from the terminal insertion position to the housing removal position, and a movement from the housing supply position to the standby position are performed along the longitudinal direction, and
a movement of the housing pallet from the housing removal position to the housing supply position, and a movement from the standby position to the terminal insertion position are performed along an intersecting direction intersecting the longitudinal direction on the surface.

8. The terminal insertion unit according to claim 7, wherein the housing holder is attached to the pallet main body with an attachment position on the longitudinal direction is changeable.

9. The terminal insertion unit according to claim 6, wherein the housing holder holds the connector housing such that a rear side from which the end portion terminal is inserted therein and the electric wire with terminal extends is facing a side of the operator at the housing removal position.

10. A terminal insertion method, comprising:
a housing supply step of positioning, among two and more housing pallets to which one and more housing holders are attached, the housing holder being able to hold a connector housing in which multiple cavities into which end portion terminals of electric wires with terminal are insertable respectively, one of the housing pallet, in a circulation route of moving from a housing supply position, to a standby position, to a terminal insertion position, to a housing removal position in this sequence and then return to the housing supply position, at the housing supply position, and supplying the connector housing so as to be held by the housing holder;
a standby step of making one of the housing pallet to be positioned at the standby position so as to standby until the terminal insertion position becomes vacant in a case where other housing pallet is positioned at the terminal insertion position in prior to one of the housing pallet after housing holding, and positioning the one housing pallet at the terminal insertion position after standby;
a terminal insertion step of inserting the end portion terminal of the electric wire with terminal into the cavity of the housing pallet positioned at the terminal insertion position; and
a housing removal step of positioning the housing pallet after terminal insertion at the housing removal position to remove the connector housing from the housing holder,
wherein the housing pallets move around the circulation route only via four straight movements, including a straight movement from the housing removal position to the housing supply position, a straight movement from the housing supply position to the standby position, a straight movement from the standby position to the terminal insertion position, and a straight movement from the terminal insertion position to the housing removal position.
